(19) United States
(12) Patent Application Publication
(10) Pub. No.: US 2010/0245538 A1
(43) Pub. Date: Sep. 30, 2010

(54) METHODS AND DEVICES FOR RECEIVING AND TRANSMITTING AN INDICATION OF PRESENCE

(75) Inventors: Thomas Marzano, Eindhoven (NL); Marko Macura, Eindhoven (NL); Chi Hang Tony Wong, Singapore (SG); Megumi Fujikawa, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/742,972

(22) PCT Filed: Nov. 17, 2008
(86) PCT No.: PCT/IB08/54795

§ 371 Date: May 14, 2010

(30) Foreign Application Priority Data
Nov. 22, 2007 (EP) 07121278.1

(51) Int. Cl. H04N 7/14; G08B 21/00

(52) U.S. Cl. 348/14.12; 340/686.6

(57) ABSTRACT

The method of transmitting an indication of presence of a subject comprises the steps of detecting the presence of a subject in a first geographical area, transmitting an indication of presence of the subject to a remote system if the subject is present in the first geographical area, detecting the presence of a subject in a second geographical area, and transmitting realistic live images of the subject to the remote system if the subject is present in the second geographical area. The method of receiving an indication of presence of a remote subject comprises the steps of detecting whether an indication of presence of a remote subject is received from a remote system, detecting whether realistic live images of the remote subject are being received from the remote system, indicating a virtual presence of the remote subject if the indication of presence of the remote subject is received and the realistic live images of the remote subject are not being received, and displaying the realistic live images of the remote subject when the realistic live images of the remote subject are being received. The devices comprise electronic circuitry operative to perform the methods of the invention. The computer program product enables a programmable device to perform one or both of the methods of the invention.

### FIELD OF THE INVENTION

The invention relates to a method of transmitting an indication of presence of a subject.

The invention also relates to a method of receiving an indication of presence of a remote subject.

The invention further relates to a device for transmitting an indication of presence of a subject.

The invention also relates to a device for receiving an indication of presence of a remote subject.

The invention further relates to a computer program product enabling a programmable device to perform a method of transmitting an indication of presence of a subject and/or a method of receiving an indication of presence of a remote subject.

### BACKGROUND OF THE INVENTION

It is known from instant messaging software applications to transmit and receive indications of presence of subjects. Certain instant messaging software applications further allow a user to setup a video connection with another user. It is a drawback of the known instant messaging software applications that the user has to use a mouse or keyboard to indicate whether he/she is present or not and whether he/she wants to initiate or accept a video connection.

### SUMMARY OF THE INVENTION

It is a first object of the invention to provide methods of receiving and transmitting an indication of presence, which require little or no use of an input device such as a mouse or a keyboard.

It is a second object of the invention to provide devices for receiving and transmitting an indication of presence, which require little or no use of an input device such as a mouse or a keyboard.

According to a first aspect of the invention, the first object is realized in that the method of transmitting an indication of presence of a subject comprises the steps of detecting the presence of a subject in a first geographical area, transmitting an indication of presence of the subject to a remote system if the subject is present in the first geographical area, detecting the presence of a subject in a second geographical area, and transmitting realistic live images of the subject to the remote system if the subject is present in the second geographical area. With this method, the subject's location determines whether he/she merely wishes to indicate his/her presence or wants to initiate or accept a (realistic) video connection, the former giving more privacy to the subject than the latter.

In an embodiment of this method, transmitting an indication of presence of the subject comprises transmitting an identity of the subject, and transmitting realistic live images of the subject also comprises transmitting the identity of the subject. In order for the remote system to replace an indication of presence of the subject with realistic live images of the subject, it would be beneficial to let the remote system receive information for determining whether the indication of presence and the realistic live images belong to the same subject.

In an embodiment of this method, the indication of presence of the subject is transmitted only if the subject is not present in the second geographical area. This reduces the amount of data that needs to be transmitted. When realistic live images are transmitted, it can be assumed that the subject is present, so transmitting the indication of presence is not necessary.

Transmitting an indication of presence of the subject may comprise transmitting non-realistic live images of the subject. The non-realistic live images may be obtained by removing details from the realistic live images. By filling the outlines of the subject with a single appropriate color, ‘shadow’ images can be created. The non-realistic live images afford the subject more privacy than the realistic live images.

According to a second aspect of the invention, the first object is realized in that the method of receiving an indication of presence of a remote subject comprises the steps of detecting whether an indication of presence of a remote subject is received from a remote system, detecting whether realistic live images of the remote subject are being received from the remote system, indicating a virtual presence of the remote subject if the indication of presence of the remote subject is received and the realistic live images of the remote subject are not being received, and displaying the realistic live images of the remote subject when the realistic live images of the remote subject are being received. With this method, realistic live images of the remote subject are shown instead of the virtual presence of the remote subject when the remote subject initiates or accepts a (realistic) video connection, i.e. moves to the second geographical area at the remote location.

In an embodiment of this method, a first identity, e.g. unique username or e-mail address, is received along with the indication of presence, a second identity is received along with the realistic live images and the first identity is compared with the second identity in order to determine whether the indication of presence and the realistic live images relate to the same subject. In order to replace an indication of presence of the subject with realistic live images of the subject, it would be beneficial to receive information for determining whether the indication of presence and the realistic live images belong to the same subject.

Indicating a virtual presence of the remote subject may comprise displaying a non-realistic image of the remote subject. Indicating a virtual presence of the remote subject may comprise displaying non-realistic live images of the remote subject. By filling the outlines of the subject with a single appropriate color, one or more ‘shadow’ images can be created. The non-realistic image or images afford the subject more privacy than realistic live images.

According to a third aspect of the invention, the second object is realized in that the device for transmitting an indication of presence of a subject comprises electronic circuitry operative to detect the presence of a subject in a first geographical area, transmit an indication of presence of the subject to a remote system if the subject is present in the first geographical area, detect the presence of a subject in a second geographical area, and transmit realistic live images of the subject to the remote system if the subject is present in the second geographical area.

According to a fourth aspect of the invention, the second object is realized in that the device for receiving an indication of presence of a remote subject comprises electronic circuitry operative to detect whether an indication of presence of a remote subject is received from a remote system, detect whether realistic live images of the remote subject are being received from the remote system, indicate a virtual presence of the remote subject if the indication of presence of the remote subject is received and the realistic live images of the remote subject are not being received, and display the realistic live images of the remote subject when the realistic live images of the remote subject are being received.

### BRIEF DESCRIPTION OF THE DRAWINGS

These and other aspects of the invention are apparent from and will be further elucidated, by way of example, with reference to the drawings, in which:

FIG. 1 shows a first illustration of an embodiment of the method in which two subjects are in remote first geographical areas;

FIG. 2 shows a second illustration of the embodiment of the method in which one subject is in a remote first geographical area and another subject is entering a remote second geographical area; and

FIG. 3 is a block diagram showing two embodiments of the devices of the invention from a 3D perspective.

Corresponding elements in the drawings are denoted by the same reference numerals.

### DETAILED DESCRIPTION OF THE EMBODIMENTS

The method of transmitting an indication of presence of a subject comprises at least four steps. A first step comprises detecting the presence of a subject in a first geographical area. A second step comprises transmitting an indication of presence of the subject to a remote system if the subject is present in the first geographical area. A third step comprises detecting the presence of a subject in a second geographical area. A fourth step comprises transmitting realistic live images of the subject to the remote system if the subject is present in the second geographical area.

The method of receiving an indication of presence of a remote subject also comprises at least four steps. A first step comprises detecting whether an indication of presence of a remote subject is received from a remote system. A second step comprises detecting whether realistic live images of the remote subject are being received from the remote system. A third step comprises indicating a virtual presence of the remote subject if the indication of presence of the remote subject is received and the realistic live images of the remote subject are not being received. A fourth step comprises displaying the realistic live images of the remote subject when the realistic live images of the remote subject are being received.

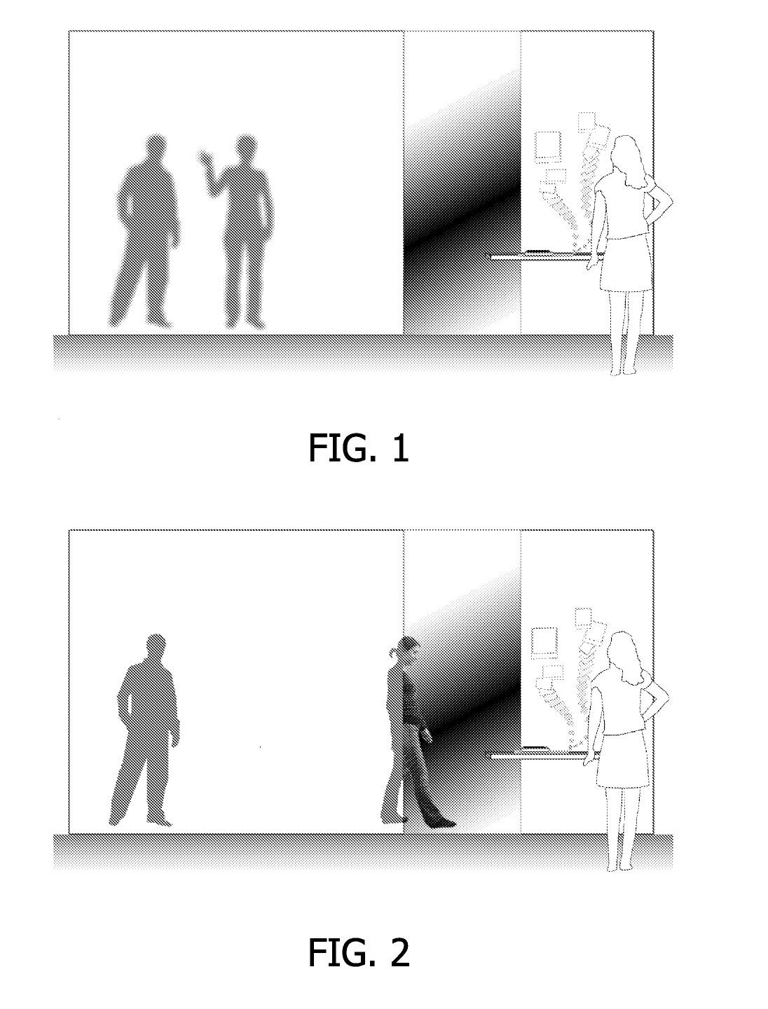

The execution of these steps has been illustrated in FIGS. 1 and 2. In the situation depicted by FIG. 1, two remote subjects are in a first geographical area at their locations. Indications of presence of these subjects are transmitted by the remote systems and received by the local system in the form of ‘shadow’ images (which are non-realistic live images). The ‘shadow’ images are displayed in the left part of the display. In the situation depicted by FIG. 2, one of the two remote subjects moves from the first geographical area into the second geographical area at her location. As soon as she enters the second geographical area, realistic live images are transmitted by the corresponding remote system. These realistic live images are received on the local system which displays them in a different part of the display. As soon as she has completely entered the second geographical area at her location, her “shadow” images are no longer displayed (not shown). The different part of the display may be a combination of a display and a mirror to indicate that when a person is positioned in front of that part of the display (i.e. the mirror), realistic live images of him/her are transmitted to a remote system.

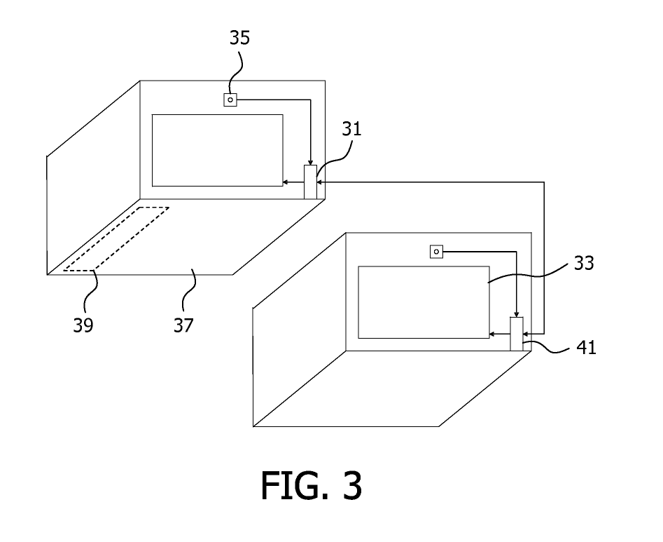

FIG. 3 shows a three-dimensional view on two rooms, a local room having a local electronic device 31 of the invention and a remote room having a remote electronic device 41 of the invention. The electronic device 31 comprises electronic circuitry operative to detect the presence of a subject in a first geographical area 37, transmit an indication of presence of the subject to the remote electronic device 41 if the subject is present in the first geographical area 37 (represented in FIG. 3 by a part of the floor surface), detect the presence of a subject in a second geographical area 39 (represented in FIG. 3 by a part of the floor surface), and transmit realistic live images of the subject to the remote electronic device 41 if the subject is present in the second geographical area 39. The presence of the subject in the second geographical area may be detected with a camera 35. The camera 35 may also be used to capture the realistic live images. The same camera 35 may further be used to detect the presence of the subject in the first geographical area. Alternatively, a second camera, a motion sensor or a heat sensor (not shown) may be used to detect the presence of the subject in the first geographical area. Other means for detecting the presence of the subject in a geographical area can also be used, e.g. RFID. In this embodiment, geographical area 39 is part of geographical area 37, but this is not necessarily the case in other embodiments.

The remote electronic device 41 is operative to detect whether an indication of presence of the subject is received from the local electronic device 31, detect whether realistic live images of the subject are being received from the local electronic device 31, indicate a virtual presence of the subject if the indication of presence of the subject is received and the realistic live images of the subject are not being received, and display the realistic live images of the subject when the realistic live images of the subject are being received. The realistic live images may be displayed on a display 33, which may be, for example, a relatively large LCD, Plasma, OLED or projection display. The virtual presence of the subject may be indicated on a different part of the same display 33. Alternatively, a second display (not shown) may be used to indicate the virtual presence of the subject. “Shadow” images may be displayed on the display 33 or on the second display in order to indicate the virtual presence of the subject. Other means for indicating the virtual presence of the subject can also be used.

The remote electronic device 41 may further perform the functions of the local electronic device 31 and vice versa. The local electronic device 31 and the remote electronic device 41 may be interconnected through the Internet, for example. The electronic circuitry may be, for example, a general-purpose or an application-specific processor. The electronic circuitry may be capable of executing a computer program. The electronic devices 31 and 41 may be PCs, for example. Alternatively, the electronic circuitry may be embedded in display 33 or camera 35, for example.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The invention can be implemented by means of hardware comprising several distinct elements, and by means of a suitably programmed computer. ‘Computer program product’ is to be understood to mean any software product stored on a computer-readable medium, such as a floppy disk, downloadable via a network, such as the Internet, or marketable in any other manner.

1. A method of transmitting an indication of presence of a subject, comprising the steps of:
detecting the presence of a subject in a first geographical area;
transmitting an indication of presence of the subject to a remote system if the subject is present in the first geographical area;
detecting the presence of a subject in a second geographical area; and
transmitting realistic live images of the subject to the remote system if the subject is present in the second geographical area.

2. A method as claimed in claim 1, wherein transmitting an indication of presence of the subject comprises transmitting an identity of the subject, and transmitting realistic live images of the subject also comprises transmitting the identity of the subject.

3. A method as claimed in claim 1, wherein the indication of presence of the subject is transmitted only if the subject is not present in the second geographical area.

4. A method as claimed in claim 1, wherein transmitting an indication of presence of the subject comprises transmitting non-realistic live images of the subject.

5. A method as claimed in claim 4, wherein the non-realistic live images are obtained by removing details from the realistic live images.

6. A method of receiving an indication of presence of a remote subject, comprising the steps of:
detecting whether an indication of presence of a remote subject is received from a remote system;
detecting whether realistic live images of the remote subject are being received from the remote system;
indicating a virtual presence of the remote subject if the indication of presence of the remote subject is received and the realistic live images of the remote subject are not being received; and
displaying the realistic live images of the remote subject when the realistic live images of the remote subject are being received.

7. A method as claimed in claim 6, wherein a first identity is received along with the indication of presence, a second identity is received along with the realistic live images, and the first identity is compared with the second identity in order to determine whether the indication of presence and the realistic live images relate to the same subject.

8. A method as claimed in claim 6, wherein indicating a virtual presence of the remote subject comprises displaying a non-realistic image of the remote subject.

9. A method as claimed in claim 8, wherein indicating a virtual presence of the remote subject comprises displaying non-realistic live images of the remote subject.

10. A computer program product enabling a programmable device to perform the method of claim 1.

11. A device (31) for transmitting an indication of presence of a subject, comprising electronic circuitry, the electronic circuitry being operative to:
detect the presence of a subject in a first geographical area (37);
transmit an indication of presence of the subject to a remote system (41) if the subject is present in the first geographical area (37);
detect the presence of a subject in a second geographical area (39); and
transmit realistic live images of the subject to the remote system (41) if the subject is present in the second geographical area (39).

12. A device (41) for receiving an indication of presence of a remote subject, comprising electronic circuitry, the electronic circuitry being operative to:
detect whether an indication of presence of a remote subject is received from a remote system (31);
detect whether realistic live images of the remote subject are being received from the remote system (31);
indicate a virtual presence of the remote subject if the indication of presence of the remote subject is received and the realistic live images of the remote subject are not being received; and
display the realistic live images of the remote subject when the realistic live images of the remote subject are being received.
